(19) United States
(12) Patent Application Publication
(10) Pub. No.: US 2003/0170483 A1
(43) Pub. Date: Sep. 11, 2003

(54) Coating system

(76) Inventors: Ernst-Walter Hillebrand, Wickede (DE); Manfred Hofschneider, Wuppertal (DE); Jurgen Tomaszewski, Langenfeld (DE); Roel Kraijenbrink, Vallienswaard (NL)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/361,314

(22) Filed: Feb. 10, 2003

Related U.S. Application Data
(63) Continuation of application No. 09/763,000, filed on Mar. 28, 2001, now abandoned.
Application No. 09/763,000 is a 371 of international application No. PCT/EP99/06018, filed on Aug. 17, 1999.

(30) Foreign Application Priority Data
Aug. 18, 1998 (DE) 198 37 286.8
Aug. 17, 1999 (DE) 199 38 575.0

(51) Int. Cl. B32B 15/00

(52) U.S. Cl. 428/624; 428/658

(57) ABSTRACT

The invention relates to a coating system for the lubricant coating of components. The system includes an electrodeposited oxidatively pretreated zinc-nickel coating and a dry lubricant layer and offers considerably improved adhesive properties as well as greater corrosion resistance and resistance to chemicals.

The invention relates to a coating system for coating components with a lubricant, in particular for fastening elements for wheels and rollers.

The use of dry lubricants as what is referred to as an anti-friction coating for improving the sliding properties of surfaces and for reducing the surface roughness is known. In this context, use is made, for example, of coating systems containing PTFE or graphite. The use of systems based on MoS₂ is also known.

It is also known to pretreat the surface to which the dry lubricant is to be applied, in order to improve the anticorrosion properties. In order to improve the adhesion properties of the dry lubricant on the component or on the substrate, a zinc or manganese phosphate layer which increases the surface roughness is used as the substrate in the prior art.

However, in none of the known cases are the adhesion properties and the anticorrosion properties of known systems satisfactory. For bolts, in particular, the prior art has the problem that sliding behaviour cannot be reproduced. This problem is particularly serious in the sector concerned with wheel bolts for motor vehicles. Because the sliding properties are not clearly defined, it is not possible for reproducible screwing-in properties to be derived from the torque which is selected.

In this case, a ratio of tightening torque to prestressing force to be set within predetermined limits is desirable. In the prior art, however, at a specified tightening torque for the connecting element the prestressing force lies within a certain variation range. This variation range is increased by the use of different materials (light metal alloys, preferably aluminium or magnesium alloys or steel).

The mechanical stress caused by multiple fitting and the physical impact which occurs in practice and temperature effects are also problematical.

Another problem which has a particular effect in the sector concerned with motor-vehicle wheel bolts is bolt corrosion, the bolt being attacked by moisture particularly on its flanks which are not bearing against the thread.

The invention is therefore based on the problem of providing a coating system for coating components with dry lubricants, which has considerably improved adhesion properties, increased corrosion resistance and also good resistance to chemicals.

The problem is solved by a coating system in which the dry lubricant is applied to a zinc/nickel layer which has been treated beforehand with an oxidant. Alternatively, it is also possible for the dry lubricant to be applied to a conversion layer which then lies between the zinc/nickel layer, which has been treated by oxidation, and the dry lubricant. Organic or inorganic coating agents, for example silicates or polymer waxes, are suitable as the conversion layer. The product Aquares is particularly suitable.

With the coating system according to the invention excellent, reproducible pairing properties with different materials are achieved.

A particular advantage of the invention resides in the fact that the combination of a zinc/nickel layer, which has been treated by oxidation, and a dry lubricant has great durability with respect to physical and chemical influences and nevertheless has good flow properties at the same time. The ratio of tightening torque to prestressing force in the case of connecting elements which are coated in accordance with the invention remains unchanged even in the case of multiple removal and refitting—even when repeated around 20 times. The prestressing force which is achieved remains within tight limits at a specified tightening torque even when different materials are used. In particular, the adhesiveness and abrasion resistance of the system according to the invention and the impact resistance are considerably improved compared to the prior art.

This may be further reinforced by the use of a conversion layer. In this connection, the anti-friction coating Molykote D708 supplied by Molykote is preferably used as the dry lubricant. Temperature stability of −180 to 200° C. is achieved by this system.

Furthermore, irregularities in the thread of the hole are compensated for with the aid of the dry lubricant. In the system according to the invention the optimized flow properties bring about self-sealing of damage to the outer skin. Corrosion stresses in vehicles are considerable, particularly in the chassis region—where wheel bolts are used. Even with these exceptional stresses, the system according to the invention produces excellent cathodic protection against corrosion and particular resistance to contact corrosion using a very wide variety of materials (light metal alloys, in particular aluminium or magnesium alloys or steel). Even under more difficult conditions of use, this avoids there being any possibility of attack by corrosive substances or other chemicals which act on the coating. The system according to the invention also withstands particular chemical stresses as arise when using aggressive cleaning agents, for example for cleaning aluminium wheel rims.

A particular advantage of using zinc/nickel black, which has been treated by oxidation, with the coating system according to the invention resides in the fact that the black colouring which conventional systems require is omitted, which facilitates the visual checking of the coating system and which reduces top-layer coating processes.

The colouring of the object coated with the aid of the coating system according to the invention is maintained even after prolonged, intensive use and has scarcely any visible changes, which is of significance particularly in the case of a black covering system

This is also of significance in the coating of internal contours (preferably depressions or internal applications of a force), for example in the case of bolt connecting elements, in order to satisfy the decorative requirements and requirements concerned with protection against corrosion. In the case of wheel bolts, this applies especially to the internal contour of the bolt head.

The dry lubricant is preferably deposited by a dipping and centrifuging process and is subsequently baked.

Contact corrosion is avoided by a colloidal carton-black binding.

1. Coating system for coating components with a lubricant, characterized by a zinc/nickel layer which is applied by electroplating and has been pretreated by oxidation, and a dry lubricant layer.

2. Coating system according to claim 1, characterized by a conversion layer between the zinc/nickel layer and the dry lubricant.

3. Coating system according to claim 1 or 2, characterized in that the product D708 supplied by Molykote is used as the dry lubricant.
